(19) United States
(12) Patent Application Publication
(10) Pub. No.: US 2017/0276008 A1
(43) Pub. Date: Sep. 28, 2017

(54) ENERGY RECOVERY APPARATUS FOR A REFRIGERATION SYSTEM

(71) Applicant: REGAL BELOIT AMERICA, INC., Beloit, WI (US)

(72) Inventors: Steven W. Post, Cassville, MO (US); Bobby D. Garrison, Cassville, MO (US)

(21) Appl. No.: 15/508,567

(22) PCT Filed: Sep. 4, 2014
(86) PCT No.: PCT/US14/54002

§ 371 Date: Mar. 3, 2017

(51) Int. Cl. F01D 15/10; H02K 7/18; F25B 9/06; F01D 15/00

(52) U.S. Cl. CPC F01D 15/10; F01D 15/005; H02K 7/1823; F25B 9/06; F25B 2400/14; F25B 2309/06; F25B 11/02

(57) ABSTRACT

An energy recovery apparatus for use in a refrigeration system, comprises an intake port, a nozzle, a turbine and a discharge port. The intake port is adapted to be in fluid communication with a refrigerant cooler of a refrigeration system. The nozzle comprises a fluid passageway. The nozzle is configured to increase velocity of the refrigerant as it passes through the fluid passage -way. The turbine is positioned relative to the nozzle and configured to be driven by refrigerant discharged from the fluid passageway. The discharge port is downstream of the turbine and is configured to be in fluid communication with an evaporator of the refrigeration system.

### CROSS REFERENCE TO RELATED APPLICATIONS

None.

### STATEMENT REGARDING FEDERALLY SPONSORED RESEARCH OR DEVELOPMENT

Not Applicable.

### APPENDIX

Not Applicable

### BACKGROUND OF THE INVENTION

### Field of the Invention

The present invention pertains to an energy recovery apparatus for use in a refrigeration system.

### SUMMARY OF THE INVENTION

One aspect of the present invention is a method comprising selling an energy recovery apparatus. The energy recovery apparatus comprises an intake port adapted to be in fluid communication with the refrigerant cooler, a discharge port adapted to be in fluid communication with the evaporator, a nozzle, and a turbine. The nozzle comprises a necked-down region and a tube portion. The tube portion is downstream of the necked-down region. The necked-down region has a downstream end having a cross-sectional area less than a cross-sectional area of the intake port of the energy recovery apparatus. The nozzle is configured to increase velocity of the refrigerant as it passes through the nozzle. The turbine is positioned and configured to be driven by refrigerant discharged from the nozzle. The discharge port of the energy recovery apparatus is downstream of the turbine. The nozzle is adapted and configured such that refrigerant entering the nozzle is reduced in temperature and pressure as it passes through the nozzle and is discharged from the nozzle in a liquid-vapor. The nozzle is also adapted and configured such that the liquid refrigerant discharged from the nozzle has a velocity that is at least 60% of the velocity of the vapor refrigerant discharged from the nozzle. The energy recovery apparatus further comprises a generator coupled to the turbine and driven by the turbine. The generator is configured to produce electricity as a result of the turbine being driven by refrigerant discharged from the nozzle. The energy recovery apparatus further comprises a housing encompassing the turbine and the generator. The method further comprises including with the energy recovery apparatus indicia (e.g., instructions, explanation, etc.) that the energy recovery apparatus is to be placed in fluid communication with an evaporator of a refrigeration system.

Another aspect of the present invention is a method comprising modifying a refrigeration system. The refrigeration system comprises an evaporator, a compressor, a refrigerant cooler and a throttle valve. The evaporator comprises an intake port and a discharge port. The evaporator is configured to evaporate a cold refrigerant from a liquid-vapor state to a vapor state. The compressor comprises an intake port and a discharge port. The intake port of the compressor is in fluid communication with the discharge port of the evaporator. The compressor is configured to receive refrigerant discharged from the evaporator and compress the refrigerant. The refrigerant cooler comprises an intake port and a discharge port. The intake port of the refrigerant cooler is in fluid communication with the discharge port of the compressor. The refrigerant cooler is configured to receive refrigerant discharged from the compressor. The throttle valve comprises an intake port and a discharge port. The intake port of the throttle valve is in fluid communication with the discharge port of the refrigerant cooler. The discharge port of the throttle valve is in fluid communication with intake port of the evaporator. The method comprising replacing the throttle valve with an energy recovery apparatus. The energy recovery apparatus comprises an intake port adapted to be in fluid communication with the refrigerant cooler, a discharge port adapted to be in fluid communication with the evaporator, a nozzle, and a turbine. The nozzle comprises a necked-down region and a tube portion. The tube portion is downstream of the necked-down region. The necked-down region has a downstream end having cross-sectional area less than a cross-sectional area of the intake port of the energy recovery apparatus. The nozzle is configured to increase velocity of the refrigerant as it passes through the nozzle. The turbine is positioned and configured to be driven by refrigerant discharged from the nozzle. The discharge port of the energy recovery apparatus is downstream of the turbine. The nozzle is adapted and configured such that refrigerant entering the nozzle is reduced in temperature and pressure as it passes through the nozzle and is discharged from the nozzle in a liquid-vapor state. The nozzle is also adapted and configured such that the liquid refrigerant discharged from the nozzle has a velocity that is at least 60% of the velocity of the vapor refrigerant discharged from the nozzle.

Another aspect of the present invention is an energy recovery apparatus for use in a refrigeration system. The refrigeration system comprises an evaporator, a compressor and a refrigerant cooler. The evaporator is configured to evaporate a cold refrigerant from a liquid-vapor state to a vapor state. The energy recovery apparatus comprises an intake port, a discharge port, a nozzle, a turbine, a generator, and a housing. The intake port is adapted to be in fluid communication with the refrigerant cooler. The discharge port is adapted to be in fluid communication with the evaporator. The nozzle is adapted and configured to increase velocity of the refrigerant as it passes through the nozzle. The turbine is positioned and configured to be driven by refrigerant discharged from the nozzle. The discharge port of the energy recovery apparatus is downstream of the turbine. The generator is coupled to the turbine and driven by the turbine. The generator is configured to produce electricity as a result of the turbine being driven by refrigerant discharged from the nozzle. The housing encompasses the turbine and the generator.

Another aspect of the present invention is an energy recovery apparatus for use in a refrigeration system. The refrigeration system comprises an evaporator, a compressor, and a refrigerant cooler. The refrigeration system is configured to circulate refrigerant along a flow path such that the refrigerant flows from the evaporator to the compressor, and from the compressor to the refrigerant cooler, and from the refrigerant cooler to the evaporator. The energy recovery apparatus is adapted and configured to be in the flow path operatively between the refrigerant cooler and the evaporator. The energy recovery apparatus comprises an intake port, a discharge port, a nozzle, a turbine, a generator and a housing. The intake port is adapted to permit refrigerant to flow into the energy recovery apparatus. The discharge port is adapted to permit refrigerant to flow out of the energy recovery apparatus. The nozzle comprises a conduit region downstream of the intake port. The conduit region defines a passageway. The passageway is adapted to constitute a portion of the flow path. The passageway has an upstream cross-section, a downstream cross-section, a passageway length extending from the upstream cross-section to the downstream cross-section, and a discharge end. The downstream cross-section of the passageway is closer to the discharge end of the passageway than to the upstream cross-section. The passageway at the downstream cross-section has an effective diameter. The effective diameter is defined as (4A/π)^{1/2}, where A is the cross-sectional area of the passageway at the downstream cross-section. The passageway length is at least five times the effective diameter. The nozzle is adapted and configured such that refrigerant entering the nozzle is reduced in temperature and pressure as it passes through the nozzle and is discharged from the discharge end of the passageway in a liquid-vapor state with a liquid component and a vapor component. The turbine is positioned and configured to be driven by refrigerant discharged from the discharge end of the passageway. The discharge port of the energy recovery apparatus is downstream of the turbine. The generator is coupled to the turbine and adapted to be driven by the turbine. The generator is configured to produce electricity as a result of the turbine being driven by refrigerant discharged from the discharge end of the passageway. The turbine and the generator are within the housing.

Another aspect of the present invention is an energy recovery apparatus for use in a refrigeration system. The refrigeration system comprises an evaporator, a compressor, and a refrigerant cooler. The refrigeration system is configured to circulate refrigerant along a flow path such that the refrigerant flows from the evaporator to the compressor, and from the compressor to the refrigerant cooler, and from the refrigerant cooler to the evaporator. The energy recovery apparatus is adapted and configured to be in the flow path operatively between the refrigerant cooler and the evaporator. The energy recovery apparatus comprises an intake port, a discharge port, a nozzle, a turbine, a generator and a housing. The intake port is adapted to permit refrigerant to flow into the energy recovery apparatus. The discharge port is adapted to permit refrigerant to flow out of the energy recovery apparatus. The nozzle comprises a conduit region downstream of the intake port. The conduit region defines a passageway. The passageway is adapted to constitute a portion of the flow path. The passageway has an upstream cross-section, a downstream cross-section, a passageway length extending from the upstream cross-section to the downstream cross-section, and a discharge end. The discharge end of the passageway is adjacent the downstream cross-section of the passageway. The nozzle is adapted and configured such that refrigerant entering the nozzle is reduced in temperature and pressure as it passes through the nozzle and is discharged from the discharge end of the passageway in a liquid-vapor state with a liquid component and a vapor component. The nozzle is adapted and configured to discharge the liquid component of the refrigerant from the discharge end of the passageway at a velocity of at least about 190 feet per second (58 m/s). The turbine is positioned and configured to be driven by refrigerant discharged from the discharge end of the passageway. The discharge port of the energy recovery apparatus is downstream of the turbine. The generator is coupled to the turbine and adapted to be driven by the turbine. The generator is configured to produce electricity as a result of the turbine being driven by refrigerant discharged from the discharge end of the passageway. The turbine and the generator are within the housing.

Another aspect of the present invention is an energy recovery apparatus for use in a refrigeration system. The refrigeration system comprises an evaporator, a compressor, and a refrigerant cooler. The refrigeration system is configured to circulate refrigerant along a flow path such that the refrigerant flows from the evaporator to the compressor, and from the compressor to the refrigerant cooler, and from the refrigerant cooler to the evaporator. The energy recovery apparatus is adapted and configured to be in the flow path operatively between the refrigerant cooler and the evaporator. The energy recovery apparatus comprises an intake port, a discharge port, a nozzle, a turbine, a generator, and a housing. The intake port is adapted to permit refrigerant to flow into the energy recovery apparatus. The discharge port is adapted to permit refrigerant to flow out of the energy recovery apparatus. The nozzle comprises a conduit region downstream of the intake port. The conduit region defines a passageway. The passageway is adapted to constitute a portion of the flow path. The passageway has an upstream cross-section, a downstream cross-section, a passageway length extending from the upstream cross-section to the downstream cross-section, and a discharge end. The discharge end of the passageway is adjacent the downstream cross-section of the passageway. The cross-sectional area of the passageway at the downstream cross-section is not greater than the cross-sectional area of the passageway at any point along the passageway length. The nozzle is adapted and configured such that refrigerant entering the nozzle is reduced in temperature and pressure as it passes through the nozzle and is discharged from the discharge end of the passageway in a liquid-vapor state with a liquid component and a vapor component. The nozzle is adapted and configured such that the liquid component of the refrigerant discharged from the discharge end of the passageway has a velocity that is at least 60% that of the vapor component of the refrigerant discharged from the discharge end of the passageway. The turbine is positioned and configured to be driven by refrigerant discharged from the discharge end of the passageway. The discharge port of the energy recovery apparatus is downstream of the turbine. The generator is coupled to the turbine and adapted to be driven by the turbine. The generator is configured to produce electricity as a result of the turbine being driven by refrigerant discharged from the discharge end of the passageway. The turbine and the generator are within the housing.

Another aspect of the present invention is a trans-critical refrigeration system comprising an evaporator, a compressor, a gas cooler, and an energy recovery apparatus. The refrigeration system is configured to circulate refrigerant along a flow path such that the refrigerant flows from the evaporator to the compressor, and from the compressor to the gas cooler, and from the gas cooler to the energy recovery apparatus, and from the energy recovery apparatus to the evaporator. The energy recovery apparatus comprises an intake port, a discharge port, a nozzle, a turbine, a generator, and a housing. The intake port is adapted to permit refrigerant to flow into the energy recovery apparatus. The discharge port is adapted to permit refrigerant to flow out of the energy recovery apparatus. The nozzle comprises a conduit region downstream of the intake port. The conduit region defines a passageway. The passageway is adapted to constitute a portion of the flow path. The passageway has an upstream cross-section, a downstream cross-section, a passageway length extending from the upstream cross-section to the downstream cross-section, and a discharge end. The discharge end of the passageway coincides with the downstream cross-section of the passageway. The nozzle is adapted and configured such that refrigerant entering the nozzle is reduced in temperature and pressure as it passes through the nozzle and is discharged from the discharge end of the passageway in a liquid-vapor state with a liquid component and a vapor component. The nozzle is adapted and configured such that the liquid component of the refrigerant discharged from the discharge end of the passageway has a velocity that is at least 60% that of the vapor component of the refrigerant discharged from the discharge end of the passageway. The turbine is positioned and configured to be driven by refrigerant discharged from the discharge end of the passageway. The discharge port of the energy recovery apparatus is downstream of the turbine. The generator is coupled to the turbine and adapted to be driven by the turbine. The generator is configured to produce electricity as a result of the turbine being driven by refrigerant discharged from the discharge end of the passageway. The turbine and the generator are within the housing.

Another aspect of the present invention is a trans-critical refrigeration system comprising an evaporator, a compressor, a gas cooler, and an energy recovery apparatus. The refrigeration system is configured to circulate refrigerant along a flow path such that the refrigerant flows from the evaporator to the compressor, and from the compressor to the gas cooler, and from the gas cooler to the energy recovery apparatus, and from the energy recovery apparatus to the evaporator. The energy recovery apparatus comprises an intake port, a discharge port, a nozzle, a turbine, a generator, and a housing. The intake port is adapted to permit refrigerant to flow into the energy recovery apparatus. The discharge port is adapted to permit refrigerant to flow out of the energy recovery apparatus. The nozzle comprises a conduit region downstream of the intake port. The conduit region defines a passageway. The passageway is adapted to constitute a portion of the flow path. The passageway has an upstream cross-section, a downstream cross-section, a passageway length extending from the upstream cross-section to the downstream cross-section, and a discharge end. The discharge end of the passageway coincides with the downstream cross-section of the passageway. The nozzle is adapted and configured such that refrigerant entering the nozzle is reduced in temperature and pressure as it passes through the nozzle and is discharged from the discharge end of the passageway in a liquid-vapor state with a liquid component and a vapor component, the nozzle being adapted and configured to discharge the liquid component of the refrigerant from the discharge end of the passageway at a velocity of at least about 190 feet per second (58 m/s). The turbine is positioned and configured to be driven by refrigerant discharged from the discharge end of the passageway. The discharge port of the energy recovery apparatus is downstream of the turbine. The generator is coupled to the turbine and adapted to be driven by the turbine. The generator is configured to produce electricity as a result of the turbine being driven by refrigerant discharged from the discharge end of the passageway. The turbine and generator are within the housing.

Another aspect of the present invention is an energy recovery apparatus for use in a trans-critical refrigeration system. The refrigeration system comprises an evaporator, a compressor, and a gas cooler. The refrigeration system is configured to circulate refrigerant along a flow path such that the refrigerant flows from the evaporator to the compressor, and from the compressor to the gas cooler, and from the gas cooler to the evaporator. The energy recovery apparatus is adapted and configured to be in the flow path operatively between the gas cooler and the evaporator. The energy recovery apparatus comprises an intake port, a discharge port, a nozzle, a turbine, a generator and a housing. The intake port is adapted to permit refrigerant to flow into the energy recovery apparatus. The discharge port is adapted to permit refrigerant to flow out of the energy recovery apparatus. The nozzle comprises a conduit region downstream of the intake port. The conduit region defines a passageway. The passageway is adapted to constitute a portion of the flow path. The passageway has an upstream cross-section, a downstream cross-section, a passageway length extending from the upstream cross-section to the downstream cross-section, and a discharge end. The downstream cross-section of the passageway is closer to the discharge end of the passageway than to the upstream cross-section. The passageway at the downstream cross-section has an effective diameter. The effective diameter is defined as (4A/π)^{1/2}, where A is the cross-sectional area of the passageway at the downstream cross-section. The passageway length is at least five times the effective diameter. The nozzle is adapted and configured such that refrigerant entering the nozzle is reduced in temperature and pressure as it passes through the nozzle and is discharged from the discharge end of the passageway in a liquid-vapor state with a liquid component and a vapor component. The turbine is positioned and configured to be driven by refrigerant discharged from the discharge end of the passageway. The discharge port of the energy recovery apparatus is downstream of the turbine. The generator is coupled to the turbine and adapted to be driven by the turbine. The generator is configured to produce electricity as a result of the turbine being driven by refrigerant discharged from the discharge end of the passageway. The turbine and the generator are within the housing.

Another aspect of the present invention is an energy recovery apparatus for use in a trans-critical refrigeration system. The trans-critical refrigeration system comprises an evaporator, a compressor, and a gas cooler. The refrigeration system is configured to circulate refrigerant along a flow path such that the refrigerant flows from the evaporator to the compressor, and from the compressor to the gas cooler, and from the gas cooler to the evaporator. The energy recovery apparatus is adapted and configured to be in the flow path operatively between the gas cooler and the evaporator. The energy recovery apparatus comprises an intake port, a discharge port, a nozzle, a turbine, a generator and a housing. The intake port is adapted to permit refrigerant to flow into the energy recovery apparatus. The discharge port is adapted to permit refrigerant to flow out of the energy recovery apparatus. The nozzle comprises a conduit region downstream of the intake port. The conduit region defines a passageway. The passageway is adapted to constitute a portion of the flow path. The passageway has an upstream cross-section, a downstream cross-section, a passageway length extending from the upstream cross-section to the downstream cross-section, and a discharge end. The discharge end of the passageway is adjacent the downstream cross-section of the passageway. The nozzle is adapted and configured such that refrigerant entering the nozzle is reduced in temperature and pressure as it passes through the nozzle and is discharged from the discharge end of the passageway in a liquid-vapor state with a liquid component and a vapor component. The nozzle is adapted and configured to discharge the liquid component of the refrigerant from the discharge end of the passageway at a velocity of at least about 190 feet per second (58 m/s). The turbine is positioned and configured to be driven by refrigerant discharged from the discharge end of the passageway. The discharge port of the energy recovery apparatus is downstream of the turbine. The generator is coupled to the turbine and adapted to be driven by the turbine. The generator is configured to produce electricity as a result of the turbine being driven by refrigerant discharged from the discharge end of the passageway. The turbine and the generator are within the housing.

Another aspect of the present invention is an energy recovery apparatus for use in a refrigeration system. The refrigeration system comprises an evaporator, a compressor, and a gas cooler. The refrigeration system is configured to circulate refrigerant along a flow path such that the refrigerant flows from the evaporator to the compressor, and from the compressor to the gas cooler, and from the gas cooler to the evaporator. The energy recovery apparatus is adapted and configured to be in the flow path operatively between the gas cooler and the evaporator. The energy recovery apparatus comprises an intake port, a discharge port, a nozzle, a turbine, a generator, and a housing. The intake port is adapted to permit refrigerant to flow into the energy recovery apparatus. The discharge port is adapted to permit refrigerant to flow out of the energy recovery apparatus. The nozzle comprises a conduit region downstream of the intake port. The conduit region defines a passageway. The passageway is adapted to constitute a portion of the flow path. The passageway has an upstream cross-section, a downstream cross-section, a passageway length extending from the upstream cross-section to the downstream cross-section, and a discharge end. The discharge end of the passageway is adjacent the downstream cross-section of the passageway. The cross-sectional area of the passageway at the downstream cross-section is not greater than the cross-sectional area of the passageway at any point along the passageway length. The nozzle is adapted and configured such that refrigerant entering the nozzle is reduced in temperature and pressure as it passes through the nozzle and is discharged from the discharge end of the passageway in a liquid-vapor state with a liquid component and a vapor component. The nozzle is adapted and configured such that the liquid component of the refrigerant discharged from the discharge end of the passageway has a velocity that is at least 60% that of the vapor component of the refrigerant discharged from the discharge end of the passageway. The turbine is positioned and configured to be driven by refrigerant discharged from the discharge end of the passageway. The discharge port of the energy recovery apparatus is downstream of the turbine. The generator is coupled to the turbine and adapted to be driven by the turbine. The generator is configured to produce electricity as a result of the turbine being driven by refrigerant discharged from the discharge end of the passageway. The turbine and the generator are within the housing.

### BRIEF DESCRIPTION OF THE DRAWINGS

FIG. 1 is a schematic representation of an embodiment of a refrigeration system of the present invention.

FIG. 2 is a perspective view of an embodiment of an energy recovery apparatus of the present invention.

FIG. 3 is a top plan view of the energy recovery apparatus of FIG. 5

FIG. 4 is a cross-sectional view taken along the plane of line 4-4 of FIG. 3.

FIG. 5 is a side-elevational view of the energy recovery apparatus of FIG. 2.

FIG. 6 is a cross-sectional view taken along the plane of line 6-6 of FIG. 5.

FIG. 7 is a cross-sectional view of another embodiment of an energy recovery apparatus of the present invention, similar to FIG. 6, but having a converging tube portion.

FIG. 8 is a cross-sectional view of another embodiment of an energy recovery apparatus of the present invention, similar to FIG. 6, but having a diverging tube portion.

Reference numerals in the written specification and in the drawing figures indicate corresponding items.

### DETAILED DESCRIPTION OF THE PREFERRED EMBODIMENTS OF THE INVENTION

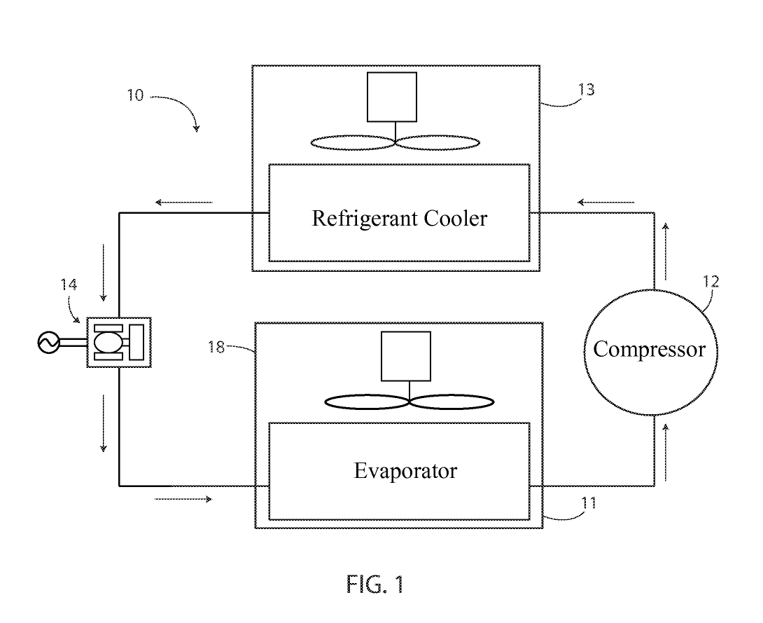

An embodiment of a refrigeration system of the present invention is indicated generally by reference numeral 10 in FIG. 1. The refrigeration system 10 comprises an evaporator 11, a compressor 12, a refrigerant cooler 13 (e.g., condenser or gas cooler), and an energy recovery apparatus 14. The refrigeration system 10 is configured to circulate refrigerant along a flow path such that the refrigerant flows from the evaporator 11 to the compressor 12, and from the compressor to the refrigerant cooler 13, and from the refrigerant cooler to the evaporator. The refrigeration system 10 may be a sub-critical refrigeration system, with the refrigerant cooler 13 being a condenser. Alternatively, the refrigeration system 10 may be a trans-critical refrigeration system, with the refrigerant cooler 13 being a gas cooler. If the refrigeration system 10 is a trans-critical refrigeration system, the refrigerant may be any suitable refrigerant, such as carbon dioxide.

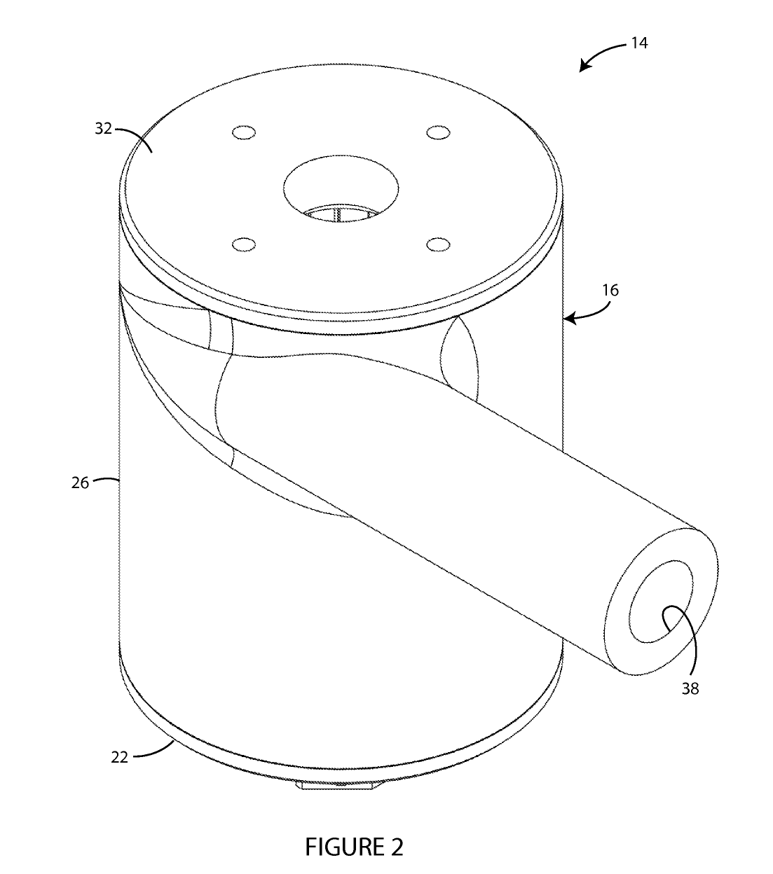

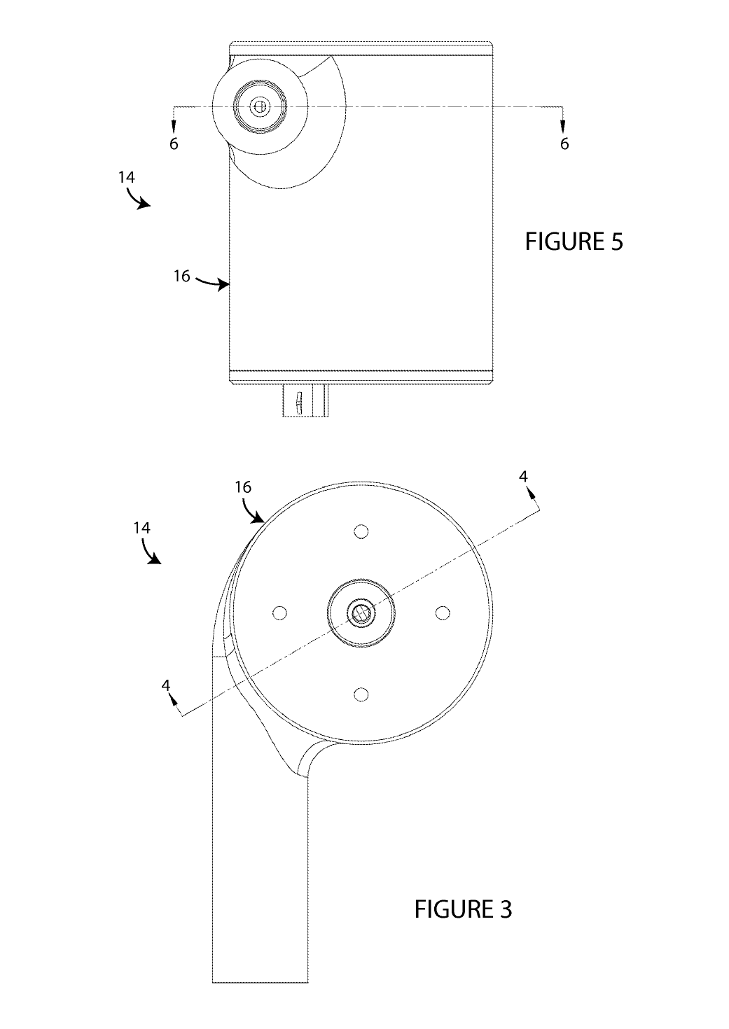

An embodiment of an energy recovery apparatus of the present invention is indicated generally by reference numeral 14 in FIGS. 2-6. The energy recovery apparatus 14 is basically comprised of a housing 16, a turbine 18 and a generator 20. The turbine 18 and generator 20 are preferably contained in the housing.

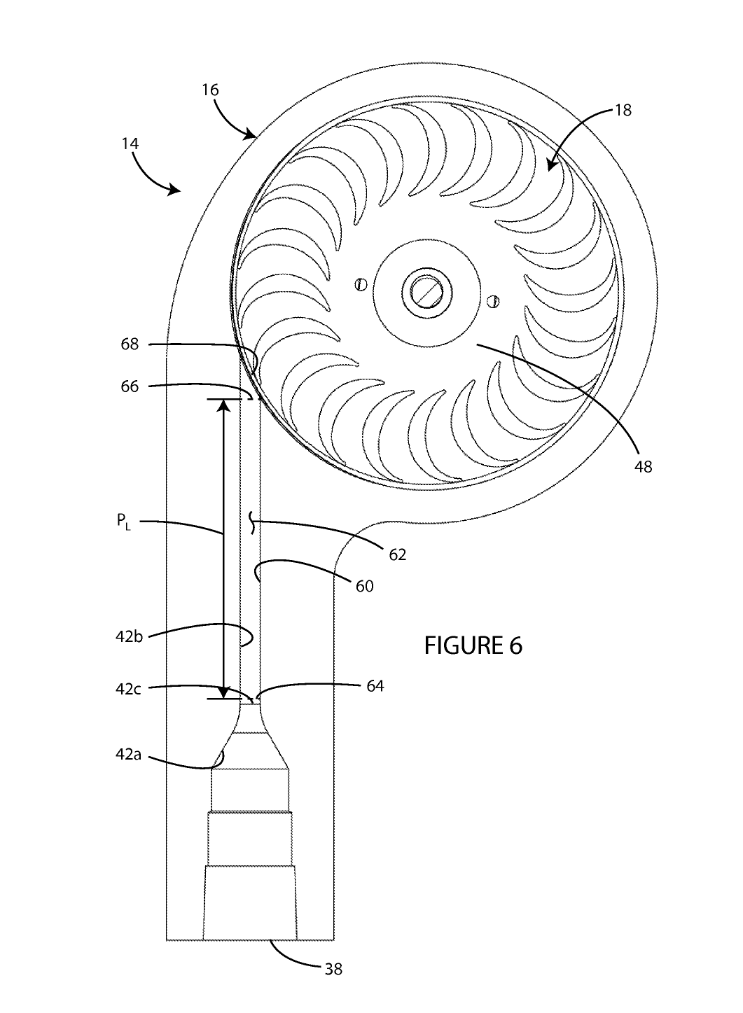

The housing 16 is preferably comprised of three parts. A first, lower center housing part 22 has an interior that supports a bearing assembly 24. The center part 22 is attached to a second, side wall part 26 of the housing. The side wall 26 is preferably generally cylindrical in shape and extends around an interior volume of the housing 16. The center housing part 22 also includes a hollow center column 28. The interior of the center column 28 supports a second bearing assembly 30. A third, cover part of the housing 32 is attached to the top of the side wall 26. The cover part 32 encloses the hollow interior of the housing 16. The center housing part 22 preferably has an outlet opening (or discharge port) 34 that is the outlet for the refrigerant passing through the energy recovery apparatus 14. The discharge port 34 of the energy recovery apparatus 14 is downstream of the turbine 18. The housing side wall 26 is preferably formed with a refrigerant inlet opening 38. This is the inlet for the refrigerant entering the energy recovery apparatus 14. Referring to FIG. 6, the housing side wall 26 includes a nozzle 40 inside the inlet opening 38. Preferably, the nozzle 40 is integrally formed with the side wall 26 as a single, unitary, monolithic piece. The nozzle 40 preferably includes a necked-down region 42a and a tube portion 42b. The necked-down region 42a is downstream of the inlet opening 38, and the tube portion 42b is downstream of the necked-down region. The necked-down region 42a has a downstream end 42c. The downstream end 42c of the necked-down region 42a has a cross-sectional area less than a cross-sectional area of the intake opening 38 of the energy recovery apparatus. Preferably, the necked-down region 42a gradually decreases in cross-sectional area toward its downstream end 42c. Alternatively, the necked-down region may abruptly decrease in cross-sectional area without departing from the scope of the present invention. The tube portion 42b has an inlet end and a downstream (or discharge) end that opens into the interior of the housing 16 and in particular adjacent the turbine 18. The tube portion 42b is preferably in the form of a cylindrical bore, but can be of other shapes without departing from the scope of this invention. The necked-down region 42a may be integral with the tube portion 42b or the necked-down region may be a separate piece joined to the tube portion. In the present embodiment, at least a portion of the tube portion 42b comprises a conduit region 60. The conduit region 60 defines a passageway 62. The passageway 62 is downstream of the necked down region 42a. The necked-down region 42a and the passageway 62 are adapted to constitute portions of a flow path of a refrigeration system. In other words, when the energy recovery apparatus 14 is in the refrigeration system and the refrigeration system is operating to circulate refrigerant, the necked-down region 42a is a portion of the refrigerant flow path and the passageway is a portion of the refrigerant flow path. The passageway 62 has an upstream cross-section, indicated by the dash line 64, a downstream cross-section, indicated by the dash line 66, a passageway length P_{L} extending from the upstream cross-section to the downstream cross-section, and a discharge end 68. The downstream cross-section 66 is closer to the discharge end 68 of the passageway than to the upstream cross section 64. In the present embodiment, the downstream cross-section 66 of the passageway 62 is adjacent the downstream end 68 of the passageway. The cross-sectional area of the passageway 62 at the downstream cross-section 66 is not greater than the cross-sectional area of the passageway at any point along the passageway length P_{L}. The passageway 62 at the downstream cross-section 66 has an effective diameter. The effective diameter is defined as (4A/π)^{1/2}, where A is the cross-sectional area of the passageway at the downstream cross-section 66. As used herein, the cross-sectional area is the planar area generally perpendicular to the intended direction of flow at the given point in the passageway, e.g., at the downstream cross-section 66. The cross section of the passageway at any point along the passageway length P_{L} is preferably circular, but it is to be understood that other cross-sectional shapes may be employed without departing from this invention. The passageway length P_{L} is preferably at least five times the effective diameter, and more preferably at least seven and one-half times the effective diameter, and even more preferably at least ten times the effective diameter, and still more preferably at least twelve times the effective diameter.

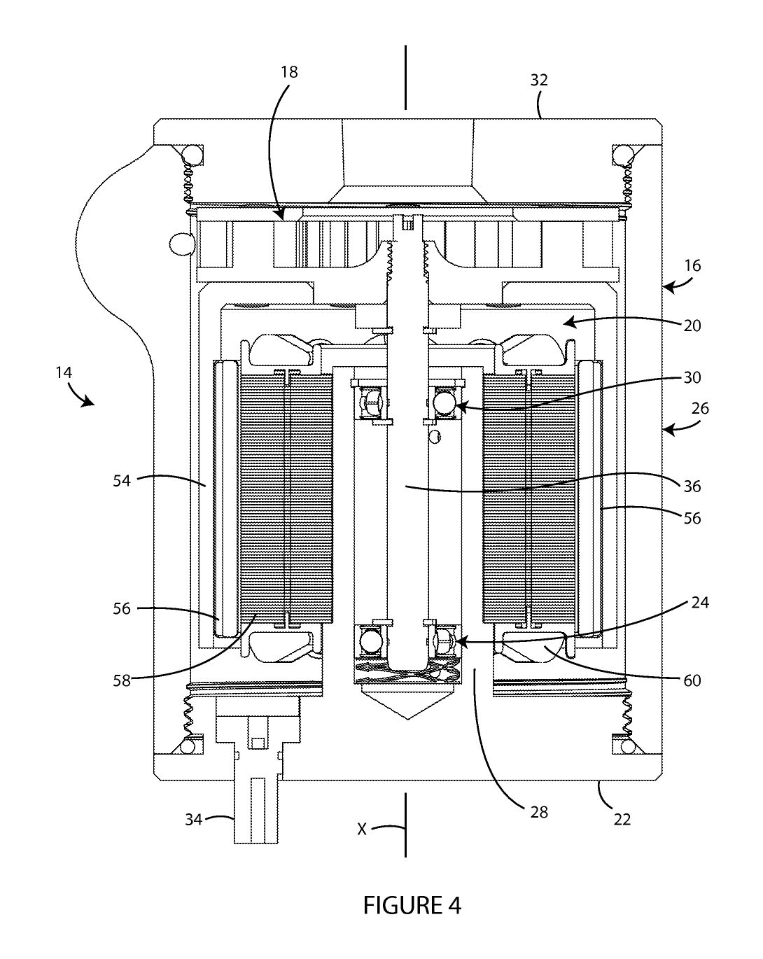

The turbine 18 includes a center shaft 36 mounted for rotation in the two bearing assemblies 24, 30. As shown in FIGS. 4 and 6, a turbine wheel 48 is mounted on the top of the turbine shaft 36 for rotation with the shaft. The turbine 18 is preferably a single-stage turbine that is comprised of a row of blades 50 that project upwardly from the turbine wheel 48 with each of the turbine blades being radially spaced from the turbine axis as shown in FIGS. 4 and 6. The turbine blades 50 are secured to and rotate with the turbine wheel 48. Refrigerant entering the housing 16 through the nozzle 40 passes through the blades 50 on the turbine wheel 48 before exiting the housing 16 through the outlet opening 34. The bottom surface of the turbine wheel 48 opposite the turbine blades 50 has a cylindrical wall 54 attached thereto. The cylindrical wall 54 is the rotor backing that supports permanent magnets 56 as shown in FIG. 4. The cylindrical wall 54 and ten permanent magnets 56 form the outside rotor of the generator 20. The generator 20 is preferably a ten pole generator comprised of a stack of stator plates 58 and six stator windings 60. The stack of stator plates 58 is secured stationary on the center column 28 of the center housing part 22. It is to be understood that other types of generators may be employed with the nozzle turbine system without departing from the scope of this invention.

Referring to FIG. 6, the passageway 62 preferably has a generally constant cross-sectional area along the passageway length P_{L}. For sub-critical refrigeration systems using R410 refrigerant and having a capacity of five tons (60,000 btu/hr) of cooling capacity or less, the cross-sectional area of the passageway 62 is preferably between about 0.0023 in²/(ton of cooling capacity) (1.48 mm²/(ton of cooling capacity)) and about 0.0031 in²/(ton of cooling capacity) (2.00 mm²/(ton of cooling capacity)) and the cross-sectional area of the intake opening 38 is about 0.022 in²/(ton of cooling capacity) (14.2 mm²/(ton of cooling capacity)) 0.11 in² (71 mm²). Thus, for a five ton sub-critical refrigeration system using R410 refrigerant, the cross-sectional area of the tube portion 42b is between about 0.012 in² (7.4 mm²) and about 0.016 in² (10 mm²) and the cross-sectional area of the intake opening 38 is about 0.11 in² (71 mm²). Also, the cross-sectional area of the tube portion 42b may be substantially the same as the cross-sectional area of the necked-down region 42a. The vapor content of the refrigerant increases as the refrigerant passes through the nozzle 42. The nozzle 42 increases the velocity of the refrigerant. In a sub-critical system, the nozzle 42 is shaped and configured such that refrigerant entering the nozzle at X % liquid and (100-X)% vapor, by mass, is expanded as it passes through the nozzle and is discharged from the discharge end 68 of the passageway 62 in a liquid-vapor state with a liquid component that is at most at (X-5)% and a vapor component liquid that is at least (105-X)%, by mass. One of ordinary skill in the art will appreciate that “X”, as used herein, is typically the number 100, but could be a number somewhat less than 100. As a first example, the nozzle 42 is shaped and configured such that refrigerant entering the nozzle at 100% liquid (and 0% vapor) by mass, is expanded as it passes through the nozzle and is discharged from the discharge end 68 of the passageway 62 in a liquid-vapor state that is at most 90% liquid, by mass (and at least 10% vapor, by mass). As a second example, the nozzle 42 is shaped and configured such that refrigerant entering the nozzle at 98% liquid (and 2% vapor) by mass, is expanded as it passes through the nozzle and is discharged from the discharge end 68 of the passageway 62 in a liquid-vapor state that is at most 88% liquid, by mass (and at least 12% vapor, by mass). More preferably, the nozzle 42 is adapted and configured such that refrigerant entering the nozzle at X % liquid and (100-X)% vapor, by mass, is expanded as it passes through the nozzle and is discharged from the discharge end 68 of the passageway 62 in a liquid-vapor state that is at least at (X-20)% liquid and at most (120-X)% vapor, by mass. Regardless of whether the energy recovery apparatus 14 is used in a sub-critical or trans-critical system, the nozzle 42 may be adapted and configured such that the liquid component of the refrigerant discharged from the discharge end 68 of the passageway 62 preferably has a velocity that is at least 60% of the velocity of the vapor component of the refrigerant discharged from the discharge end 68 of the passageway 62, and more preferably has a velocity that is at least 70% of the velocity of the vapor component discharged from the discharge end 68 of the passageway 62. If the refrigerant is expanded too rapidly in the nozzle 42 (e.g., if the passageway 62 is insufficiently long), then the velocity of the liquid component will be insufficient to impart the desired force on the turbine blades 50. Preferably, the nozzle 42 is configured such that the liquid component of the refrigerant is discharged from the discharge end 68 of the passageway 62 at a velocity of at least about 190 feet per second (58 m/s), and more preferably at a velocity of at least about 220 feet per second (67 m/s).

In operation of the energy recovery apparatus 14 of the invention in a refrigerant system (e.g., an air conditioning system) such as that shown in FIG. 1, entry of refrigerant into the housing 16 through the nozzle 40 results in a clockwise rotation of the turbine wheel 48 (as viewed in FIG. 6) relative to the housing. The refrigerant passes through the energy recovery apparatus 14 and exits through the housing outlet opening 34.

The refrigerant passing through the energy recovery apparatus 14 causes rotation of the turbine wheel 48 and the turbine shaft 46, which also causes rotation of the permanent magnets 56 on the cylindrical wall 54 of the rotor of the generator 20. The rotation of the permanent magnets 56 induces a current in the stator windings 60 which produces electricity from the energy recovery apparatus 14. The electricity produced can be routed back to a fan of the air conditioning system to help power its needs. This increases the energy efficiency of the air conditioning system and increases the SEER rating and the EER rating of the air conditioning system. The energy recovery apparatus 14 also increases the capacity of the evaporator by increasing the liquid percentage of the refrigerant entering the evaporator. It is also to be understood that the generator could be omitted. In a system without the generator, the turbine could be used to turn a fan or otherwise power (e.g., mechanically power) some component of the air conditioning system.

Preferably, the housing 16, the turbine 18 and the generator 20 are arranged and configured such that refrigerant introduced into the housing cools and lubricates the generator. The housing 16 is configured such that, during normal operation of the energy recovery apparatus 14, refrigerant passing through the energy recovery apparatus escapes from the housing 16 only via the discharge port 34. The turbine and generator are in fluid communication with each other such that at least some refrigerant directed to the turbine is able to flow to the generator. The internal generator also eliminates any external shafts that would have to be refrigerant sealed. In other words, the housing 116 is preferably devoid of any openings for the passage of external shafts. As shown in FIG. 6, the housing 16 includes 0-rings for preventing refrigerant leakage between the sidewall part 16 and the center housing part 22 and cover part 32. Alternatively, the housing parts may be sealed by any suitable means, e.g., by welding, for preventing refrigerant leakage between housing parts.

In operation, the intake port 38 of the energy recovery apparatus 14 is operatively coupled (e.g., via a refrigerant line) in fluid communication to the discharge port of a refrigerant cooler of a refrigerant system such that refrigerant discharged from the refrigerant cooler flows into the energy recovery apparatus. The refrigerant is discharged from the nozzle 42 at a low temperature, high velocity liquid-vapor and toward the blades 50 of the turbine 18. The refrigerant impacting the turbine blades causes the turbine to rotate about the turbine axis X, which also causes rotation of the permanent magnets on the cylindrical wall which form the rotor of the generator 20. The rotation of the permanent magnets induces a current in the stator windings of the generator to thereby produce electricity. The refrigerant then flows through the turbine 18 and is discharged out the discharge port 34 of the energy recovery apparatus 114 and conveyed to the evaporator. Preferably, the energy recovery apparatus 14 is configured to match the refrigerant cooler and evaporator such that the refrigerant passing from the refrigerant cooler through the energy recovery apparatus enters the evaporator at a pressure and temperature desirable for the evaporator. When operated in a in typical R410A five ton system, the energy recovery apparatus 14 should generate about 100 watts of electrical power at 80° F. ambient indoor temperate and 82° F. outdoor temperature, and about 200 watts at 95° F. outdoor temperature. In other words, the energy recovery apparatus 14 recovers about ⅓ of the available expansion energy.

The energy recovery apparatus of the present invention may be sold or distributed as part of a complete refrigerant system or as a separate unit to be added to a refrigeration system (e.g., to replace a throttle valve of an existing refrigeration system). In connection with the sale or distribution of the energy recovery apparatus, a user (e.g., a purchaser of the energy recovery apparatus) is instructed that the purpose of the energy recovery apparatus is to replace the throttle valve. The user is induced to have the energy recovery apparatus placed in fluid communication with a refrigerant cooler and evaporator of a refrigeration system.

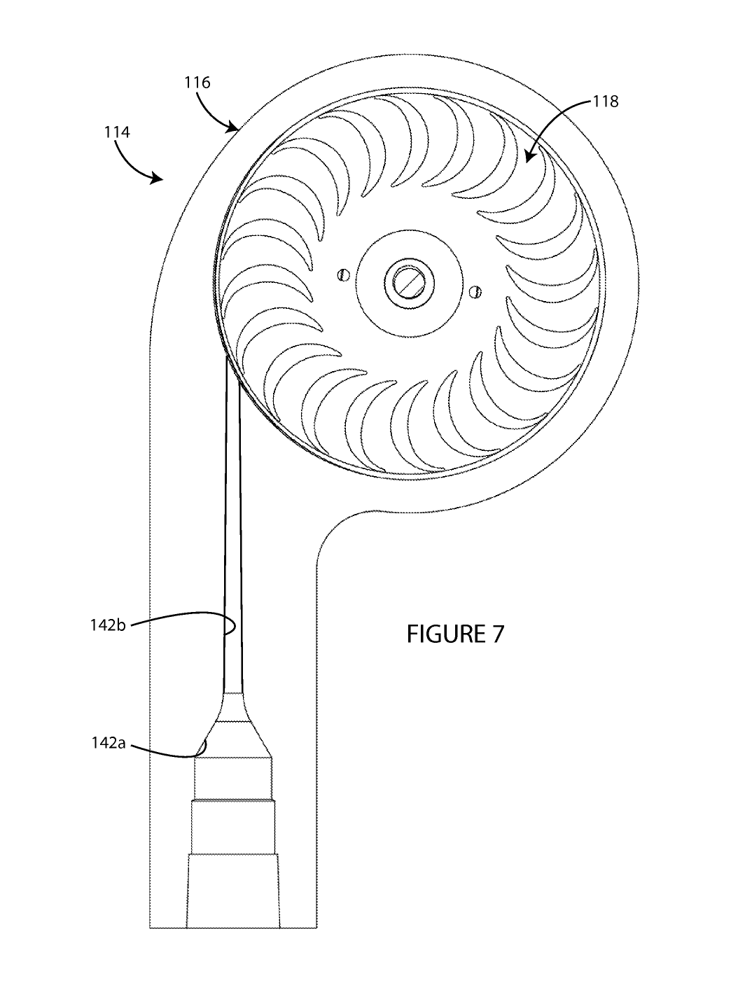

A second embodiment of an energy recovery apparatus of the present invention is indicated generally by reference numeral 114 in FIG. 7. The energy recovery apparatus 114 is basically comprised of a housing 116, a turbine 118 and a generator (not shown). The energy recovery apparatus 114 is similar to the energy recovery apparatus 14 of FIGS. 2-6 except for the differences noted herein. In particular, the tube portion 142 converges from the necked-down region 142a to the downstream end of the tube. Thus, in this embodiment, at least a portion of the passageway converges as it extends toward the discharge end of the passageway.

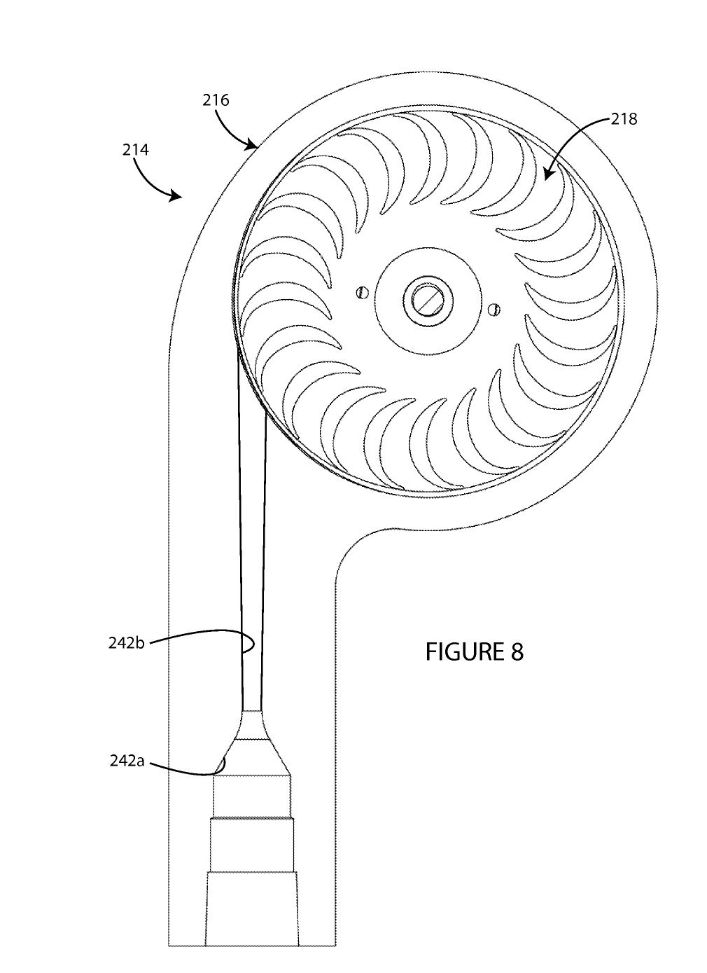

A third embodiment of an energy recovery apparatus of the present invention is indicated generally by reference numeral 214 in FIG. 8. The energy recovery apparatus 214 is basically comprised of a housing 216, a turbine 218 and a generator (not shown). The energy recovery apparatus 214 is similar to the energy recovery apparatus 14 of FIGS. 2-6 except for the differences noted herein. In particular, the tube portion 142 diverges from the necked-down region 242a to the downstream end of the tube. Thus, in this embodiment, at least a portion of the passageway diverges as it extends toward the discharge end of the passageway.

As various modifications could be made in the constructions and methods herein described and illustrated without departing from the scope of the invention, it is intended that all matter contained in the foregoing description or shown in the accompanying drawings shall be interpreted as illustrative rather than limiting. For example, although the energy recovery apparatus 14 is shown as having only one nozzle, it is to be understood that an energy recovery apparatus in accordance of the present invention may have one, two or more nozzles, such as the energy recovery apparatus described in co-pending U.S. patent application Ser. No. 14/179,899 filed Feb. 13, 2014 (incorporated herein by reference). Thus, the breadth and scope of the present invention should not be limited by any of the above-described exemplary embodiments, but should be defined only in accordance with the following claims appended hereto and their equivalents.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed.

1. A trans-critical refrigeration system comprising an evaporator, a compressor, a gas cooler, and an energy recovery apparatus, the refrigeration system being configured to circulate refrigerant along a flow path such that the refrigerant flows from the evaporator to the compressor, and from the compressor to the gas cooler, and from the gas cooler to the energy recovery apparatus, and from the energy recovery apparatus to the evaporator, the energy recovery apparatus comprising:
an intake port adapted to permit refrigerant to flow into the energy recovery apparatus;
a discharge port adapted to permit refrigerant to flow out of the energy recovery apparatus;
a nozzle comprising a conduit region downstream of the intake port, the conduit region defining a passageway, the passageway being adapted to constitute a portion of the flow path, the passageway having an upstream cross-section, a downstream cross-section, a passageway length extending from the upstream cross-section to the downstream cross-section, and a discharge end, the discharge end of the passageway coinciding with the downstream cross-section of the passageway, the nozzle being adapted and configured such that refrigerant is reduced in temperature and pressure as it passes through the nozzle and is discharged from the discharge end of the passageway in a liquid-vapor state with a liquid component and a vapor component, the nozzle being adapted and configured such that the liquid component of the refrigerant discharged from the discharge end of the passageway has a velocity that is at least 60% that of the vapor component of the refrigerant discharged from the discharge end of the passageway;
a turbine positioned and configured to be driven by refrigerant discharged from the discharge end of the passageway, the discharge port of the energy recovery apparatus being downstream of the turbine;
a generator coupled to the turbine and adapted to be driven by the turbine, the generator being configured to produce electricity as a result of the turbine being driven by refrigerant discharged from the discharge end of the passageway; and
a housing, the turbine and the generator being within the housing.

2. A trans-critical refrigeration system comprising an evaporator, a compressor, a gas cooler, and an energy recovery apparatus, the refrigeration system being configured to circulate refrigerant along a flow path such that the refrigerant flows from the evaporator to the compressor, and from the compressor to the gas cooler, and from the gas cooler to the energy recovery apparatus, and from the energy recovery apparatus to the evaporator, the energy recovery apparatus comprising:
an intake port adapted to permit refrigerant to flow into the energy recovery apparatus;
a discharge port adapted to permit refrigerant to flow out of the energy recovery apparatus;
a nozzle comprising a conduit region downstream of the intake port, the conduit region defining a passageway, the passageway being adapted to constitute a portion of the flow path, the passageway having an upstream cross-section, a downstream cross-section, a passageway length extending from the upstream cross-section to the downstream cross-section, and a discharge end, the discharge end of the passageway coinciding with the downstream cross-section of the passageway, the nozzle being adapted and configured such that refrigerant is reduced in temperature and pressure as it passes through the nozzle and is discharged from the discharge end of the passageway in a liquid-vapor state with a liquid component and a vapor component, the nozzle being adapted and configured to discharge the liquid component of the refrigerant from the discharge end of the passageway at a velocity of at least about 190 feet per second (58 m/s);
a turbine positioned and configured to be driven by refrigerant discharged from the discharge end of the passageway, the discharge port of the energy recovery apparatus being downstream of the turbine;
a generator coupled to the turbine and adapted to be driven by the turbine, the generator being configured to produce electricity as a result of the turbine being driven by refrigerant discharged from the discharge end of the passageway, and
a housing, the turbine and generator being within the housing.

3. An energy recovery apparatus for use in a trans-critical refrigeration system, the trans-critical refrigeration system comprising an evaporator, a compressor and a gas cooler, the refrigeration system being configured to circulate refrigerant along a flow path such that the refrigerant flows from the evaporator to the compressor, and from the compressor to the gas cooler, and from the gas cooler to the evaporator, the energy recovery apparatus being adapted and configured to be in the flow path operatively between the gas cooler and the evaporator, the energy recovery apparatus comprising:
an intake port adapted to permit refrigerant to flow into the energy recovery apparatus;
a discharge port adapted to permit refrigerant to flow out of the energy recovery apparatus;
a nozzle comprising a conduit region downstream of the intake port, the conduit region defining a passageway, the passageway being adapted to constitute a portion of the flow path, the passageway having an upstream cross-section, a downstream cross-section, a passageway length extending from the upstream cross-section to the downstream cross-section, and a discharge end, the downstream cross-section of the passageway being closer to the discharge end of the passageway than to the upstream cross-section, the passageway at the downstream cross-section having an effective diameter, the effective diameter being defined as (4A/π)^{1/2}, where A is the cross-sectional area of the passageway at the downstream cross-section, the passageway length being at least five times the effective diameter, the nozzle being adapted and configured such that refrigerant is reduced in temperature and pressure as it passes through the nozzle and is discharged from the discharge end of the passageway in a liquid-vapor state with a liquid component and a vapor component;
a turbine positioned and configured to be driven by refrigerant discharged from the discharge end of the passageway, the discharge port of the energy recovery apparatus being downstream of the turbine;
a generator coupled to the turbine and adapted to be driven by the turbine, the generator being configured to produce electricity as a result of the turbine being driven by refrigerant discharged from the discharge end of the passageway; and
a housing, the turbine and generator being within the housing.

4. An energy recovery apparatus as set forth in claim 3 wherein the nozzle is adapted and configured to discharge the liquid component of the refrigerant from the discharge end of the passageway at a velocity of at least about 190 feet per second (58 m/s).

5. An energy recovery apparatus as set forth in claim 3 wherein the nozzle is adapted and configured to discharge the liquid component of the refrigerant from the discharge end of the passageway at a velocity of at least about 220 feet per second (67 m/s).

6. An energy recovery apparatus as set forth in claim 3 wherein the nozzle is adapted and configured such that the liquid component of the refrigerant discharged from the discharge end of the passageway has a velocity that is at least 60% that of the vapor component of the refrigerant discharged from the discharge end of the passageway.

7. An energy recovery apparatus as set forth in claim 3 wherein the nozzle is adapted and configured such that the liquid component of the refrigerant discharged from the discharge end of the passageway has a velocity that is at least 70% that of the vapor component of the refrigerant discharged from the discharge end of the passageway.

8. An energy recovery apparatus as set forth in claim 3 wherein the intake and discharge ports constitute portions of the housing, and wherein the housing is configured such that during normal operation of the energy recovery apparatus, refrigerant passing through the energy recovery apparatus escapes from the housing only via the discharge port.

9. An energy recovery apparatus as set forth in claim 3 wherein the passageway length is at least seven and one-half times the effective diameter.

10. An energy recovery apparatus as set forth in claim 3 wherein the passageway length is at least ten times the effective diameter.

11. An energy recovery apparatus as set forth in claim 3 wherein the passageway length is at least twelve times the effective diameter.

12. An energy recovery apparatus as set forth in claim 3 wherein the passageway has a generally constant cross-sectional area along the passageway length.

13. An energy recovery apparatus for use in a refrigeration system, the refrigeration system comprising an evaporator, a compressor and a refrigerant cooler, the refrigeration system being configured to circulate refrigerant along a flow path such that the refrigerant flows from the evaporator to the compressor, and from the compressor to the refrigerant cooler, and from the refrigerant cooler to the evaporator, the energy recovery apparatus being adapted and configured to be in the flow path operatively between the refrigerant cooler and the evaporator, the energy recovery apparatus comprising:
an intake port adapted to permit refrigerant to flow into the energy recovery apparatus;
a discharge port adapted to permit refrigerant to flow out of the energy recovery apparatus;
a nozzle comprising a conduit region downstream of the intake port, the conduit region defining a passageway, the passageway being adapted to constitute a portion of the flow path, the passageway having an upstream cross-section, a downstream cross-section, a passageway length extending from the upstream cross-section to the downstream cross-section, and a discharge end, the downstream cross-section of the passageway being closer to the discharge end of the passageway than to the upstream cross-section, the passageway at the downstream cross-section having an effective diameter, the effective diameter being defined as (4A/π)^{1/2}, where A is the cross-sectional area of the passageway at the downstream cross-section, the passageway length being at least five times the effective diameter, the nozzle being adapted and configured such that refrigerant entering the nozzle is reduced in temperature and pressure as it passes through the nozzle and is discharged from the discharge end of the passageway in a liquid-vapor state with a liquid component and a vapor component;
a turbine positioned and configured to be driven by refrigerant discharged from the discharge end of the passageway, the discharge port of the energy recovery apparatus being downstream of the turbine;
a generator coupled to the turbine and adapted to be driven by the turbine, the generator being configured to produce electricity as a result of the turbine being driven by refrigerant discharged from the discharge end of the passageway; and
a housing, the turbine and generator being within the housing.

14. An energy recovery apparatus as set forth in claim 13 wherein the conduit region is integrally formed as a portion of the housing.

15. An energy recovery apparatus as set forth in claim 13 wherein the discharge end of the passageway is adjacent the downstream cross-section of the passageway.

16. An energy recovery apparatus as set forth in claim 13 wherein the cross-sectional area of the passageway at the downstream cross-section is not greater than the cross-sectional area of the passageway at any point along the passageway length.

17. An energy recovery apparatus as set forth in claim 13 wherein the housing, the turbine, and the generator are arranged and configured such that refrigerant passing through the energy recovery apparatus cools and lubricates the generator.

18. An energy recovery apparatus as set forth in claim 13 wherein the passageway length is at least seven and one-half times the effective diameter.

19. An energy recovery apparatus as set forth in claim 13 wherein the passageway length is at least ten times the effective diameter.

20. An energy recovery apparatus as set forth in claim 13 wherein the passageway length is at least twelve times the effective diameter.

21. An energy recovery apparatus as set forth in claim 13 wherein the intake and discharge ports constitute portions of the housing, and wherein the housing is configured such that during normal operation of the energy recovery apparatus, refrigerant passing through the energy recovery apparatus escapes from the housing only via the discharge port.

22. An energy recovery apparatus as set forth in claim 13 wherein the nozzle is adapted and configured such that the liquid component of the refrigerant discharged from the discharge end of the passageway has a velocity that is at least 60% that of the vapor component of the refrigerant discharged from the discharge end of the passageway.

23. An energy recovery apparatus as set forth in claim 13 wherein the nozzle is adapted and configured to discharge the liquid component of the refrigerant from the discharge end of the passageway at a velocity of at least about 190 feet per second (58 m/s).

24. An energy recovery apparatus as set forth in claim 13 wherein the passageway has a generally constant cross-sectional area along the passageway length.

25. An energy recovery apparatus as set forth in claim 13 wherein the nozzle further comprises a necked down-region, the passageway being downstream of the necked-down region, the necked-down region being adapted to constitute a portion of the flow path.

26. An energy recovery apparatus as set forth in claim 13 wherein at least a portion of the passageway converges as it extends toward the discharge end of the passageway.

27. A method comprising modifying a refrigeration system, the refrigeration system comprising an evaporator, a compressor, a refrigerant cooler, and a throttle valve, the refrigeration system being configured to circulate refrigerant along a flow path such that the refrigerant flows from the evaporator to the compressor, and from the compressor to the refrigerant cooler, and from the refrigerant cooler to the throttle valve, and from the throttle valve to the evaporator, the method comprising:
replacing the throttle valve with an energy recovery apparatus as set forth in claim 13 such that the passageway of the conduit region of the nozzle constitutes a portion of the flow path.

28. A refrigeration system comprising an evaporator, a compressor, a refrigerant cooler, and an energy recovery apparatus as set forth in claim 13, the refrigeration system being configured to circulate refrigerant along a flow path such that the refrigerant flows from the evaporator to the compressor, and from the compressor to the refrigerant cooler, and from the refrigerant cooler to the energy recovery apparatus, and from the energy recovery apparatus to the evaporator.

29. A refrigeration system as set forth in claim 28 wherein the refrigeration system comprises a sub-critical refrigeration system and the refrigerant cooler comprises a condenser.

30. A refrigeration system as set forth in claim 28 wherein the refrigeration system comprises a trans-critical refrigeration system and the refrigerant cooler comprises a gas cooler.

31.-46. (canceled)
